(19) United States
(12) Patent Application Publication
(10) Pub. No.: US 2025/0372280 A1
(43) Pub. Date: Dec. 4, 2025

(54) SHIELDED FLAT CABLE

(71) Applicant: SUMITOMO ELECTRIC INDUSTRIES, LTD., Osaka-shi (JP)

(72) Inventors: Toru NAKANISHI, Kanuma-shi (JP); Iori SUDOH, Kanuma-shi (JP)

(73) Assignee: SUMITOMO ELECTRIC INDUSTRIES, LTD., Osaka-shi (JP)

(21) Appl. No.: 19/213,331

(22) Filed: May 20, 2025

(30) Foreign Application Priority Data
May 31, 2024 (JP) 2024-089476

(51) Int. Cl. H01B 7/08

(52) U.S. Cl. CPC H01B 7/0861

(57) ABSTRACT

A shielded flat cable includes a plurality of conductors arranged in parallel and including a ground line, an insulator including a first insulator disposed on an upper surface of the plurality of conductors and a second insulator disposed on a lower surface of the plurality of conductors, a metal foil disposed above the first insulator and electrically connected to the ground line, and a shield layer electrically connected to the metal foil and disposed so as to surround outer peripheries of the insulator and the metal foil.

### CROSS REFERENCE TO RELATED APPLICATIONS

This application claims priority based on Japanese Patent Application No. 2024-089476 filed on May 31, 2024, and the entire contents of the Japanese patent application are incorporated herein by reference.

### TECHNICAL FIELD

The present disclosure relates to a shielded flat cable.

### BACKGROUND

Patent literature (Japanese Unexamined Patent Application Publication No. 2005-93178) discloses a bend-resistant shielded flexible flat cable in which a flexible flat cable is formed by covering the top and bottom of a plurality of rectangular conductors arranged at a desired distance from each other with an insulating layer having an insulating adhesive layer, and the upper and lower surfaces of the flexible flat cable are covered with a shielding covering material having an insulating layer as an outermost layer, a metal layer as an intermediate layer, and an insulating adhesive layer as an innermost layer, wherein any one or more of the rectangular conductors are used as ground conductors, and the metal layer of the shielding covering material and the ground conductor are in contact at predetermined locations.

### SUMMARY

A shielded flat cable according to the present disclosure includes a plurality of conductors arranged in parallel and including a ground line, an insulator including a first insulator disposed on an upper surface of the plurality of conductors and a second insulator disposed on a lower surface of the plurality of conductors, a metal foil disposed above the first insulator and electrically connected to the ground line, and a shield layer electrically connected to the metal foil and disposed so as to surround outer peripheries of the insulator and the metal foil.

### BRIEF DESCRIPTION OF THE DRAWINGS

FIG. 1 is a cross-sectional view of a shielded flat cable in a plane perpendicular to the longitudinal axis according to an aspect of the present disclosure.

FIG. 2 is a lower surface view of a shielded flat cable according to an aspect of the present disclosure.

FIG. 3 is an upper surface view of a shielded flat cable according to an aspect of the present disclosure.

FIG. 4 is a cross-sectional view of a shielded flat cable in a plane perpendicular to the longitudinal axis according to another aspect of the present disclosure.

FIG. 5 is a cross-sectional view of a shielded flat cable in a plane perpendicular to the longitudinal axis according to another aspect of the present disclosure.

FIG. 6 is a cross-sectional view of the shielded flat cable produced in the second example in a plane perpendicular to the longitudinal axis.

FIG. 7 is a lower surface view of the shielded flat cable produced in the second example.

FIG. 8 is an upper surface view of the shielded flat cable produced in the second example.

FIG. 9 shows the evaluation results of Ssd21 in the first example and the second example.

### DETAILED DESCRIPTION

Flexible flat cables have been used for internal wiring of various electronic devices and information devices for the purpose of space saving and easy connection.

Further, from the viewpoint of preventing the influence of noise, a shielded flat cable, which is a flexible flat cable in which a shield is disposed, has been conventionally used.

However, conventional shielded flat cables do not have sufficient noise shielding characteristics, and a shielded flat cable having excellent noise shielding characteristics has been desired.

Thus, an object of the present disclosure is to provide a shielded flat cable having excellent noise shielding characteristics.

### Description of Embodiments of Present Disclosure

Embodiments will be described below.

First, embodiments of the present disclosure will be listed and described. In the following description, the same or corresponding elements are denoted by the same reference sign, and the same description thereof will not be repeated.

(1) A shielded flat cable according to an aspect of the present disclosure includes a plurality of conductors arranged in parallel and including a ground line, an insulator including a first insulator disposed on an upper surface of the plurality of conductors and a second insulator disposed on a lower surface of the plurality of conductors, a metal foil disposed above the first insulator and electrically connected to the ground line, and a shield layer electrically connected to the metal foil and disposed so as to surround outer peripheries of the insulator and the metal foil.

In a shielded flat cable according to an aspect of the present disclosure, a ground line is connected to a shield layer by a metal foil. The ground line can be easily connected to the metal foil provided above the first insulator by, for example, bending the ground line. Further, since the metal foil and the shield layer may have a planar shape, a connection area can be sufficiently increased. Thus, electrical resistance due to the connection of the ground line, the metal foil, and the shield layer may be reduced, and noise shielding characteristics of the shielded flat cable can be enhanced.

(2) In the above (1), the ground line and the metal foil may be metallically connected to each other.

Since the ground line and the metal foil are metallically connected, electrical resistance due to connection between the ground line and the metal foil can be reduced. Further, since the connection area between the metal foil and the shield layer may be sufficiently increased, electrical resistance due to the connection between the ground line, the metal foil, and the shield layer can be sufficiently reduced, and noise shielding characteristics of the shielded flat cable can be enhanced.

(3) In the above (1) or (2), the ground line may be disposed at an end portion of an array of the plurality of conductors.

Since the ground line is disposed at the end portion of the array of the plurality of conductors, the ground line can be easily connected to the metal foil, and the productivity of the shielded flat cable can be increased.

(4) In any one of the above (1) to (3), may further include an interposed member disposed between the insulator and the metal foil.

The shielded flat cable according to an aspect of the present disclosure includes the interposed member disposed between the insulator and the metal foil, and thus impedance matching can be performed by easily adjusting the distance between the conductor and the metal foil.

(5) In (4), the interposed member may be disposed so as to cover the plurality of conductors from a first end portion to a second end portion along a longitudinal axis in a region surrounded by the shield layer.

In the region surrounded by the shield layer, impedance matching can be obtained from the first end portion to the second end portion of the conductor by covering the plurality of conductors from the first end portion to the second end portion with the interposed member.

(6) In any one of (1) to (5), the ground line may be divided into a plurality of members along a longitudinal axis of the ground line, and the ground line has at least one bent portion at an end of the ground line formed by being divided, the bent portion being bent to be positioned on an upper surface of the metal foil and metallically connected to the metal foil.

By having a bent portion in the ground line, it is possible to metallically connect the ground line and the metal foil, and reduce the electrical resistance resulting from the connection between both members. Further, since the connection area between the metal foil and the shield layer may be sufficiently increased, electrical resistance due to the connection between the ground line, the metal foil, and the shield layer can be sufficiently reduced, and noise shielding characteristics of the shielded flat cable can be enhanced.

(7) In (6), the at least one bent portion may include a plurality of bent portions.

Since the ground line has a plurality of bent portions, the number of connection points between the ground line and the metal foil is increased, electrical resistance due to connection between the ground line and the metal foil can be reduced, and noise shielding characteristics of the shielded flat cable can be enhanced.

(8) In (6) or (7), the shielded flat cable may further include an interposed member disposed between the insulator and the metal foil. In a cross section perpendicular to a longitudinal axis of the shielded flat cable at a position including the at least one bent portion, the at least one bent portion may overlap the insulator, the interposed member, and the metal foil.

The bent portion may overlap the insulator, the interposed member, and the metal foil, and thus a distance from the conductor to the bent portion may be stabilized, and impedance matching can be easily obtained.

(9) In any one of the above (1) to (5), the ground line may include a plurality of layers, and has a bent portion at one end or two ends along a longitudinal axis of the ground line. The bent portion may be formed by bending at least one of the plurality of layers so as to be positioned on an upper surface of the metal foil and being metallically connected to the metal foil.

By having the bent portion at the end of the ground line along the longitudinal axis, the ground line and the metal foil can be connected without dividing the ground line. Thus, the number of processes for manufacturing the shielded flat cable can be reduced, and the productivity can be increased.

(10) In any one of the above (1) to (9), the ground line may have an exposed portion at least partially exposed from the first insulator. The exposed portion may be metallically connected to the metal foil.

The ground line has an exposed portion exposed from the first insulator, and the exposed portion is connected to the metal foil, so that the ground line and the metal foil can be easily connected to each other as compared with the case where the ground line is bent, and the productivity of the shielded flat cable can be increased.

(11) In any one of the above (1) to (10), in a cross section perpendicular to a longitudinal axis of the shielded flat cable, the metal foil may be disposed so as to cover the plurality of conductors except at least the ground line.

Metal foil is disposed so as to cover the plurality of conductors, except the ground line, in the cross section perpendicular to the longitudinal axis of the shielded flat cable, thus maintaining a constant distance between the metal foil and the plurality of conductors, excluding the ground line. Thus, impedance matching can be obtained without depending on a conductor, and an impedance gap which is a generation source of radiation noise can be reduced or eliminated.

### Details of Embodiments of Present Disclosure

A specific example of a shielded flat cable according to one embodiment of the present disclosure (hereinafter referred to as “the embodiment”) will be described below with reference to the drawings. The present invention is not limited to these examples, but is defined by the scope of the claims, and is intended to include all modifications within the meaning and scope equivalent to the scope of the claims.

### [Shielded Flat Cable]

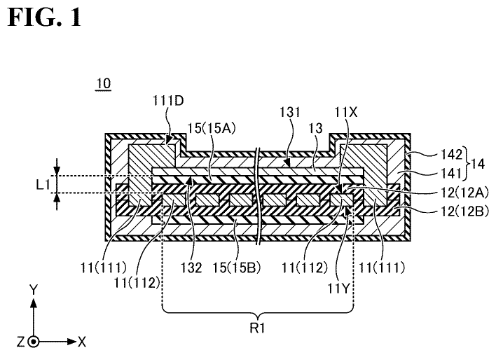

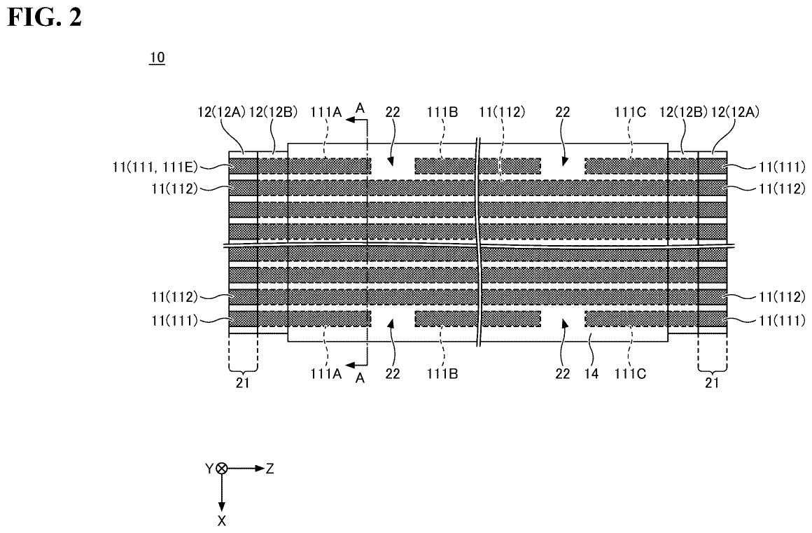

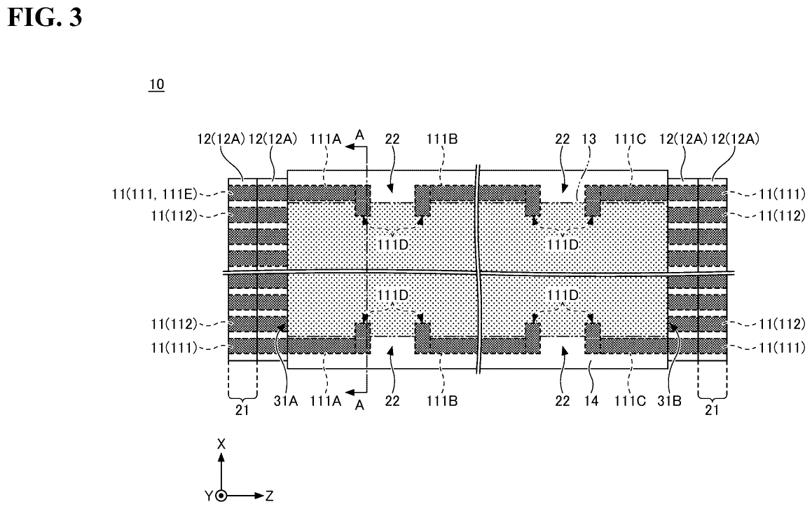

FIG. 1 shows a cross-sectional view of a shielded flat cable 10 according to the embodiment in a plane perpendicular to the longitudinal axis. FIG. 2 shows a lower surface view of the shielded flat cable 10 according to the embodiment. FIG. 3 shows an upper surface view of the shielded flat cable 10 according to the embodiment. FIG. 1 is a cross-sectional view taken along line A-A in FIG. 2 and FIG. 3.

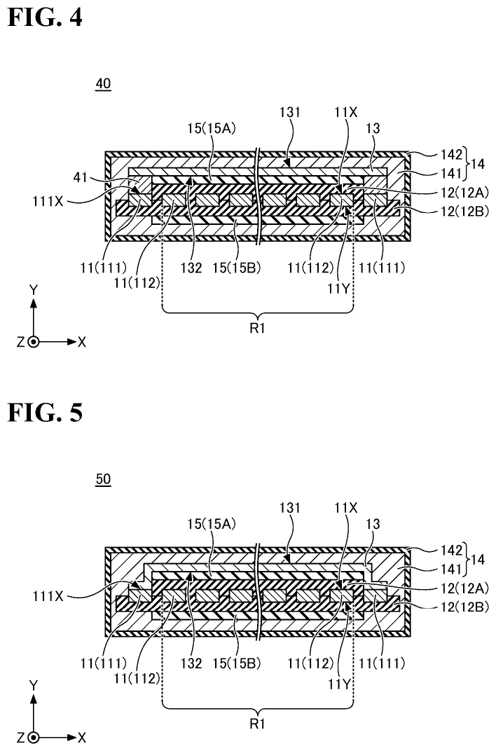

FIG. 4 and FIG. 5 are modifications of the shielded flat cable, and are cross-sectional views in a plane perpendicular to the longitudinal axis of the shielded flat cable.

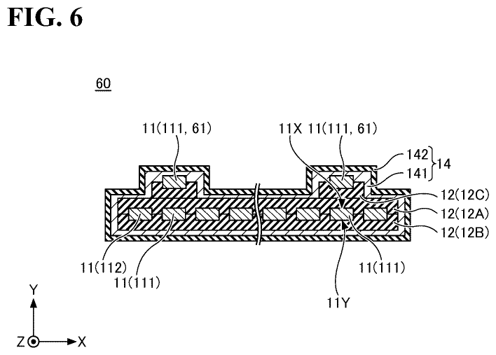

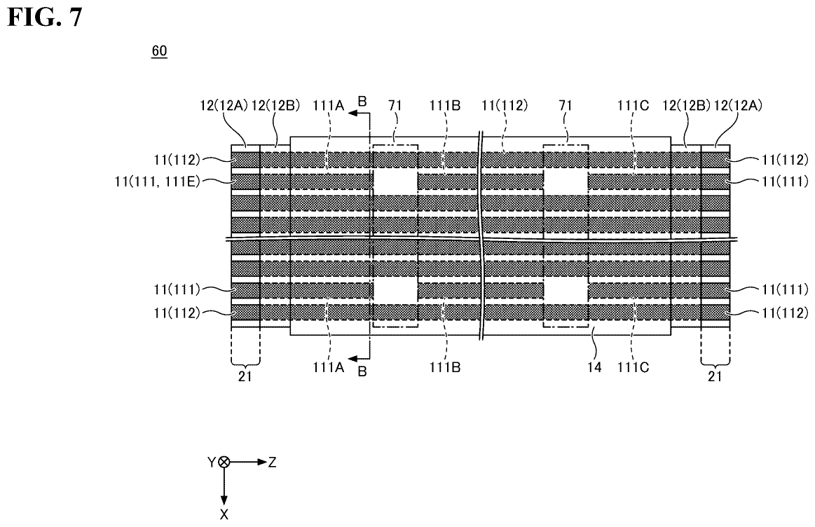

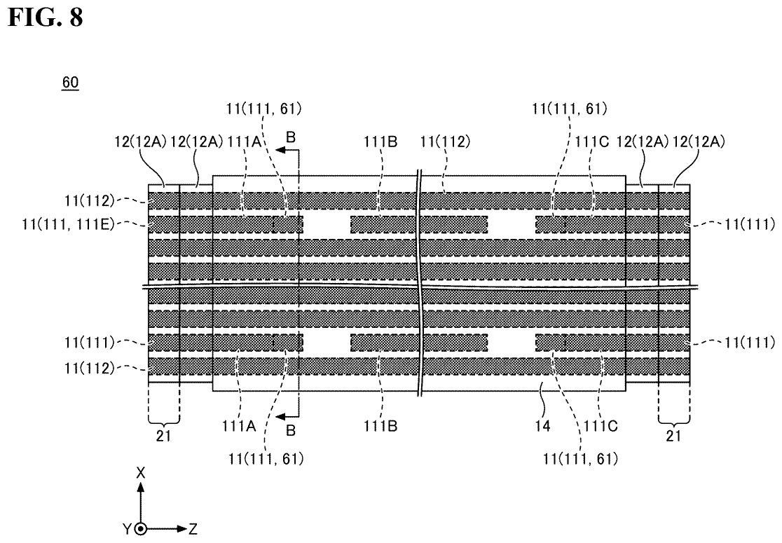

FIG. 6 shows a configuration example of a conventional shielded flat cable, which is a cross-sectional view in a plane perpendicular to the longitudinal axis of the shielded flat cable. FIG. 7 shows a lower surface view of a shielded flat cable 60 shown in FIG. 6. FIG. 8 shows an upper surface view of the shielded flat cable 60 shown in FIG. 6. FIG. 6 is a cross-sectional view taken along line B-B of FIG. 7 and FIG. 8.

In FIG. 1, FIG. 2, FIG. 3, FIG. 4, FIG. 5, FIG. 6, FIG. 7, and FIG. 8, the X-axis is an axis along an array of a plurality of conductors. The Y-axis is an axis along the thickness of the shielded flat cable 10. Further, the Z-axis is an axis along the longitudinal axis of the plurality of conductors.

As described above, FIG. 4 and FIG. 5 are modifications, and FIG. 6, FIG. 7, and FIG. 8 are explanatory diagrams of the conventional configuration example, and thus, the description will be made mainly with reference to FIG. 1 to FIG. 3, and the description will be made with reference to FIG. 4 to FIG. 8 as necessary.

For convenience of explanation in this specification, a surface positioned at the upper portion along the Y-axis in FIG. 1 to FIG. 8 may be referred to as an upper surface, and a surface positioned at the lower portion may be referred to as a lower surface. However, in the usage mode of the shielded flat cable, the direction of use changes according to the device to be connected, and the above description is not intended to limit the usage mode to the mode in which the upper surface is positioned above the lower surface.

The drawings are schematic views used for explaining the arrangement of the members of the shielded flat cable of the embodiment, and do not accurately show the ratio of the sizes of the members.

Further, in this specification, “first”, “second”, and the like may be added to the name of a member, such as “first insulator” and “second insulator”. The “first”, “second” and the like are merely described to identify each member and prevent confusion in the description, and do not represent disposition, priority, and the like. Thus, when there is no possibility of confusion or when the description is made collectively, the term “insulator” may be used.

As shown in FIG. 1, the shielded flat cable 10 of the embodiment may include a plurality of conductors 11, an insulator 12, a metal foil 13, and a shield layer 14.

(1) About each Member

Each member will be described below.

### (1-1) Conductor

The plurality of conductors 11 can be disposed in parallel so that the longitudinal axis of the conductors 11 is along the Z-axis in FIG. 1. In FIG. 1, the plurality of conductors 11 are arranged along the X-axis.

The plurality of conductors 11 may include a ground line 111. The plurality of conductors 11 may include, in addition to the ground line 111, a signal line 112 for transmitting an electric signal between connected devices, a power supply line (feeder line) for supplying electric power to the connected devices, and the like. Although only some conductors 11 are denoted by a reference sign in FIG. 1 and the like due to the paper width, the members arranged along the X-axis and having the same shape are the conductors 11.

Among the plurality of conductors 11, the arrangement of the ground line 111 is not particularly limited, but may be arranged at an end portion of the array of the plurality of conductors 11 in order to connect to the metal foil 13.

The ground line 111 is disposed at the end portion of the array of the plurality of conductors 11, that is, the end portion along the X-axis in FIG. 1, so that the ground line 111 can be easily connected to the metal foil 13, and the productivity of the shielded flat cable 10 can be increased.

Although FIG. 1 shows an example in which two ground lines 111 are disposed at both end portions of the array of the plurality of conductors 11, the number of ground lines 111 is not limited to two, and may be one, or three or more.

The shape of the plurality of conductors 11 is not particularly limited, but it can include one or more types selected from flat conductors (square conductors), round conductors, and flattened conductors, for example. The flat conductor means a conductor having a cross section perpendicular to a longitudinal axis and having a quadrangular shape. The flat conductor means a conductor whose thickness is smaller than its width, for example in a cross section perpendicular to the longitudinal axis. The round conductor means a conductor having a circular cross section perpendicular to the longitudinal axis. The flattened conductor means a conductor having a cross section perpendicular to the longitudinal axis having a shape obtained by crushing a circle, for example, an elliptical shape. The flattened conductor may be a conductor whose thickness is smaller than its width, for example in a cross section perpendicular to the longitudinal axis.

The material of the conductor 11 is not particularly limited, and copper is an example. As the copper, one or more kinds selected from annealed copper and copper alloys can be used. The surface of the conductor 11 may be plated, and for example, copper may be plated with nickel, tin, or silver.

The size of the conductor 11 is not particularly limited, but for example, when the conductor 11 is a flat conductor, the thickness may be 10 μm to 100 μm, and the width may be 0.2 mm to 0.8 mm. When the conductor 11 is a round conductor, the outer diameter may be 25 μm to 500 μm.

The conductor 11 may include conductors 11 having different sizes and shapes.

The pitch between the conductors 11 is not particularly limited, but may be arranged, for example, 0.5 mm to 1.0 mm. The pitch between the conductors 11 means the distance between the centers of the conductors 11, specifically, the distance between the centers along the width of the conductors 11.

The ground line 111 included in the conductor 11 may be divided into a plurality of members along the longitudinal axis.

Specifically, as shown in FIG. 2 and FIG. 3, the ground line 111 may be cut at a cut portion 22 and divided into a plurality of members such as a first member 111A, a second member 111B, and a third member 111C. FIG. 2 is a lower surface view (bottom plan view) of the shielded flat cable 10, and FIG. 3 is an upper surface view of the shielded flat cable 10. Thus, the plurality of conductors 11 cannot be seen directly in FIG. 2 and FIG. 3, but are shown by dotted lines in FIG. 2 and FIG. 3 so that the state of the plurality of conductors 11 can be understood.

As shown in FIG. 1 and FIG. 3, the ground line 111 may have a bent portion 111D at the end of the ground line formed by being divided. The bent portion is bent to be positioned on an upper surface 131 of the metal foil 13 and metallically connected to the metal foil 13.

It is noted that, as shown in FIG. 3, the bent portion 111D may be electrically connected to a terminal 111E of the ground line 111 exposed at a distal end portion 21 which is an end portion along the longitudinal axis of the shielded flat cable 10. Thus, the shield layer 14 may be connected to a ground terminal of a device connected to the shielded flat cable 10 by the ground line 111 and the metal foil 13.

By having the bent portion 111D in the ground line 111, it is possible to metallically connect the ground line 111 and the metal foil 13, reducing the electrical resistance (connection resistance) resulting from the connection between both members. Further, since the connection area between the metal foil 13 and the shield layer 14 can be sufficiently increased, the electrical resistance due to the connection of the ground line 111, the metal foil 13, and the shield layer 14 can be sufficiently reduced, and the noise shielding characteristics of the shielded flat cable 10 can be enhanced.

In the present specification, the connection area between the metal foil 13 and the shield layer 14 means an area of a region where the metal foil 13 and the shield layer 14 are electrically connected.

The ground line 111 may have the plurality of bent portions 111D as shown in FIG. 3. Since the ground line 111 has the plurality of bent portions 111D, the number of connection points between the ground line 111 and the metal foil 13 is increased, the electrical resistance due to the connection between the ground line 111 and the metal foil can be reduced, and the noise shielding characteristics of the shielded flat cable 10 can be enhanced.

In a cross section perpendicular to the longitudinal axis of the shielded flat cable 10 at a position including the bent portion 111D, the bent portion 111D may overlap the insulator 12, an interposed member 15, and the metal foil 13 as shown in FIG. 1. The bent portion 111D may be bent to overlap the conductor 11 other than the ground line 111, that is, to cross the conductor 11.

The bent portion 111D overlaps the insulator 12, the interposed member 15, and the metal foil 13, and thus, a distance from the conductor 11 to the bent portion 111D may be stabilized, and impedance matching can be easily obtained.

### (1-2) Insulator

The shielded flat cable 10 may have the insulator 12 including a first insulator 12A disposed on an upper surface 11X of the plurality of conductors 11 and a second insulator 12B disposed on a lower surface 11Y of the plurality of conductors 11.

As shown in FIG. 1, the first insulator 12A and the second insulator 12B can be directly contacted and bonded to each other at a portion where the conductor 11 is not disposed.

The upper surface 11X and the lower surface 11Y of the conductor 11 mean the upper surface and the lower surface of the conductor 11 along the Y-axis in FIG. 1 respectively.

The configuration of the insulator 12 is not particularly limited, and the thickness and the material of the insulator 12 can be selected according to, for example, the magnitude of impedance required for the conductor 11 included in the shielded flat cable 10.

The first insulator 12A and the second insulator 12B may each include, for example, a base material and an adhesive layer. When the first insulator 12A and the second insulator 12B include a base material and an adhesive layer, the first insulator 12A and the second insulator 12B may be layered body of the base material and the adhesive layer, respectively.

The material of the base material is not particularly limited, and a material having excellent flexibility can also be used. By using an insulator having excellent flexibility as the material of the base material, the flexibility of the shielded flat cable 10 can be increased. As the material of the base material, for example, one or more kinds selected from polyester resin, polyphenylene sulfide resin, polyimide resin, and the like can be used. Examples of the polyester resin include resin materials such as a polyethylene terephthalate resin, a polyethylene naphthalate resin, and a polybutylene naphthalate resin. The thickness of each base material can be set to, for example, 9 μm to 400 μm. The thickness and material of the base material of the first insulator 12A and the second insulator 12B may be different or the same.

The insulator 12 may have adhesive layers on the surfaces of the first insulator 12A and the second insulator 12B facing the conductor 11. Since each of the first insulator 12A and the second insulator 12B has an adhesive layer, a plurality of conductors 11 can be interposed between the first insulator 12A and the second insulator 12B with adhesive layers facing each other, for example, and then heat can be applied using a heating roller to adhere each other and integrate them.

As a material of the adhesive layer, for example, one or more kinds selected from a polyester-based resin, a polyolefin-based resin, polyvinyl chloride, and the like are exemplified. Examples of the polyolefin-based resin include polypropylene. The adhesive layer may contain an additive such as a flame retardant as necessary. The thickness of each adhesive layer may be, for example, 3 μm to 200 μm. The thickness and material of the adhesive layer of the first insulator 12A and the second insulator 12B may be different or the same.

It is noted that, the conductor 11 and the insulator 12 do not have to be bonded to each other, and thus the insulator 12 may include only the base material and not include the adhesive layer.

As shown in FIG. 2, at the distal end portion 21, which is an end portion of the shielded flat cable 10 along the longitudinal axis, the insulator 12 disposed on the upper surface 11X or the lower surface 11Y of the conductor 11 is removed to expose the conductor 11. Although FIG. 2 shows an example in which the second insulator 12B is removed at the distal end portion 21, the first insulator 12A may be removed instead of the second insulator 12B to expose the conductor 11 at the distal end portion 21.

The distal end portion 21 is a portion for connecting the shielded flat cable 10 to another device, and a connector or the like for connecting the exposed conductor 11 to another device may be provided. Further, a reinforcing member such as a reinforcing tape may be provided to reinforce the distal end portion 21.

### (1-3) Metal Foil

The shielded flat cable 10 of the embodiment may have the metal foil 13 disposed above the first insulator 12A and electrically connected to the ground line 111.

For example, as shown in FIG. 6, FIG. 7 and FIG. 8, in the conventional shielded flat cable 60, the shield layer 14 is disposed on the conductor 11 folded along the longitudinal axis of the conductor 11, and the conductor 11 and the shield layer 14 are electrically connected by a conductive adhesive. The shielded flat cable 60 will be described in detail in the second example.

However, the electrical resistance value of conductive adhesives (conductive resin) is generally higher compared to that of metal and the like, resulting in a higher electrical resistance between the conductor 11 and the shield layer 14, making it difficult to sufficiently enhance the noise shielding characteristics of the shielded flat cable 60.

In contrast, the shielded flat cable 10 of the embodiment includes the metal foil 13, and thus the ground line 111 and the metal foil 13 can be metallically connected without using the conductive adhesive.

Although a layered body of a metal layer 141 and a resin layer 142 as described later can be used for the shield layer 14, the shield layer 14 has the resin layer 142 and connecting the ground line 111 and the metal layer 141 was difficult to metallically connect. In contrast, the metal foil 13 does not include the resin layer, and thus can be metallically connected to the ground line 111.

Since the connection area between the metal foil 13 and the shield layer 14 can be sufficiently increased, even when the metal foil 13 and the shield layer 14 are bonded to each other with the conductive adhesive, the electrical resistance value can be sufficiently reduced, and the shielding property of the shielded flat cable 10 can be enhanced.

The metal foil 13 may have a structure in which a resin layer is not disposed on the upper surface 131 and a metal is exposed. An adhesive may be disposed on a lower surface 132 of the metal foil 13 for bonding to the insulator 12 and the interposed member 15. The material of the metal foil 13 is not particularly limited, and may be one or more selected from copper, aluminum, and tin-plated copper, for example.

In a cross section perpendicular to the longitudinal axis of the shielded flat cable 10, the metal foil 13 may be disposed to cover the plurality of conductors 11 except at least the ground line 111, as shown in FIG. 1. Specifically, the metal foil 13 can be disposed so as to surround a region R1 in FIG. 1 for example. By disposing the metal foil 13 to cover the plurality of conductors 11 except the ground line 111 in the cross section perpendicular to the longitudinal axis of the shielded flat cable 10, a distance L1 between the metal foil 13 and the plurality of conductors 11 except the ground line 111 can be made constant. Thus, impedance matching can be obtained without depending on the conductor 11, and the impedance gap which is a generation source of radiation noise can be reduced or eliminated.

As shown in FIG. 3, the metal foil 13 may be provided so as to cover the entire surface from a first end portion 31A to a second end portion 31B along the longitudinal axis for the plurality of conductors 11 except the ground line 111 without being interrupted by the cut portion 22 in the region surrounded by the shield layer 14. In the region surrounded by the shield layer 14, the metal foil 13 covers the plurality of conductors 11 along the longitudinal axis of the plurality of conductors 11, so that the distance L1 between the plurality of conductors 11 and the metal foil 13 is constant, and impedance matching can be obtained regardless of the conductor 11. That is, impedance matching can be obtained from the first end portion 31A to the second end portion 31B in any of the conductors 11. Thus, the impedance gap which is a generation source of radiation noise can be reduced or eliminated.

In the distal end portion 21 and the vicinity thereof, the metal foil 13 may not cover the plurality of conductors 11 in order to expose the conductors 11.

### (1-3) Shield Layer

The shielded flat cable 10 of the embodiment may have the shield layer 14 disposed to surround outer peripheries of the insulator 12 and the metal foil 13.

The shield layer 14 may be disposed above the exterior of insulator 12 and metal foil 13, specifically above the exterior surface.

The shield layer 14 may be electrically connected to the metal foil 13. A conductive adhesive may be disposed between the metal foil 13 and the shield layer 14, and the metal foil 13 and the shield layer 14 may be electrically connected to each other by the conductive adhesive. Thus, the shield layer 14 is electrically connected to the ground line 111 by the metal foil 13.

According to the shielded flat cable 10 of the embodiment, the ground line 111 is electrically connected to the shield layer 14 by the metal foil 13. The ground line 111 can be easily connected to the metal foil 13 provided above the first insulator 12A by, for example, bending the ground line 111. Further, since the metal foil 13 and the shield layer 14 may have a planar shape, respectively, a connection area may be sufficiently increased. Thus, electrical resistance due to the connection of the ground line 111, the metal foil 13, and the shield layer 14 may be reduced, and noise shielding characteristics of the shielded flat cable 10 can be enhanced.

The shield layer 14 may have the metal layer 141, and may have a structure in which the metal layer 141 and the resin layer 142 are laminated, for example, as shown in FIG. 1.

As the metal layer 141, for example, a metal foil may be used, or a metal vapor deposition film or the like formed on the resin layer 142 may be used. As for the material of the metal layer 141, any material with conductivity may be used. For example, copper or aluminum, which are relatively inexpensive and have excellent conductivity, may be used.

The resin contained in the resin layer 142 is not particularly limited as long as it is a material capable of supporting the metal layer 141, and examples thereof include polyester such as polyethylene terephthalate resin (PET) and polyethylene naphthalate resin (PEN).

Although the thickness of the shield layer 14 is not particularly limited, for example, it may be 0.2 μm to 200 μm.

The metal layer 141 constituting the shield layer 14 can be disposed on the inner side of the resin layer 142, that is, the metal layer 141 can be disposed at a position closer to the plurality of conductors 11 than the resin layer 142. Thus, the resin layer 142 is positioned on the outside of the shielded flat cable 10, and is exposed to the outside, which is preferable, for example, in terms of protection.

An adhesive layer may be provided between the shield layer 14 and the insulator 12 as necessary.

From the viewpoint of enhancing workability, the adhesive disposed between the shield layer 14 and the insulator 12 may be a conductive adhesive.

### (1-4) Interposed Member

In order to adjust the impedance of the conductor 11 by adjusting the distance between the conductor 11 and the shield layer 14 or the metal foil 13, which is an electric conductor disposed outside the conductor 11, the shielded flat cable 10 of the embodiment may have the interposed member 15.

In particular, in view of adjusting the distance between the conductor 11 and the metal foil 13, the shielded flat cable 10 of the embodiment may have the interposed member 15 disposed between the insulator 12 and the metal foil 13, specifically, a first interposed member 15A.

The shielded flat cable 10 of the embodiment has the interposed member 15 disposed between the insulator 12 and the metal foil 13, and thus the distance L1 between the conductor 11 and the metal foil 13 can be easily adjusted and impedance matching can be performed. As shown in FIG. 1, the interposed member 15 may be provided at a position where the bent portion 111D is provided. When FIG. 1 is a vertical cross section of FIG. 2, the interposed member 15 may be provided so as to overlap the plurality of conductors 11 at a position where the cut portion 22 is provided when FIG. 2 is viewed in a horizontal cross section, that is, a cross section parallel to the Z-axis. That is, as shown in FIG. 3, in the region surrounded by the shield layer 14, the interposed member 15 may be provided to cover the entire surface of the plurality of conductors 11 from the first end portion 31A to the second end portion 31B along the longitudinal axis without being interrupted by the cut portion 22 like the metal foil 13. In the region surrounded by the shield layer 14, the plurality of conductors 11 are covered with the interposed member 15 from the first end portion 31A to the second end portion 31B, and thus impedance matching can be obtained from the first end portion 31A to the second end portion 31B of the conductor 11.

The first end portion 31A and the second end portion 31B mean end portions of the conductor 11 along the longitudinal axis in the region surrounded by the shield layer 14.

Examples of the material of the interposed member 15 include polyester-based resin and polyolefin-based resin. Examples of the polyolefin-based resin include polyethylene and polypropylene. The interposed member 15 may contain an additive such as a flame retardant as necessary. The thickness of the interposed member 15 can be selected according to the characteristics required for the conductor.

Although FIG. 1 shows an example in which the shielded flat cable 10 includes the first interposed member 15A disposed above the conductor 11 and a second interposed member 15B disposed below the conductor 11, the present disclosure is not limited to such a form. The shielded flat cable 10 may include only one of the first interposed member 15A and the second interposed member 15B. When the shielded flat cable 10 includes the first interposed member 15A and the second interposed member 15B, the first interposed member 15A and the second interposed member 15B may be the same or different in material or size.

### (2) Connection Form Between Ground Line and Metal Foil

The ground line 111 and the metal foil 13 may be electrically connected to each other, and the connection form is not particularly limited, and they may be metallically connected to each other.

In this specification, the ground line 111 and the metal foil 13 being metallically connected means that they are connected by a metal material such as ultrasonic bonding or bonding by solder without a resin such as a conductive adhesive. The bonding includes laser welding and direct bonding in addition to ultrasonic bonding and soldering.

Since the ground line 111 and the metal foil 13 are metallically connected, electrical resistance due to connection between the ground line 111 and the metal foil 13 can be reduced. Further, since the connection area between the metal foil 13 and the shield layer 14 can be sufficiently increased, the electrical resistance due to the connection of the ground line 111, the metal foil 13, and the shield layer 14 can be sufficiently reduced, and the noise shielding characteristics of the shielded flat cable 10 can be enhanced.

The ground line 111 and the metal foil 13 may be metallically connected to each other.

For example, as shown in FIG. 1 and FIG. 3, the ground line 111 may be divided into the first member 111A, the second member 111B, and the third member 111C. The end of the ground line 111 formed by being divided may have the bent portion 111D that is bended so as to be positioned on the upper surface of the metal foil 13 and is metallically connected to the metal foil 13. One bent portion 111D may be provided on each of the first member 111A and the third member 111C, and two bent portions 111D may be provided on the second member 111B. One bent portion 111D may be provided on the second member 111B. At least one bent portion 111D may be provided on any one of the first member 111A, the second member 111B, and the third member 111C.

Among the plurality of conductors 11, the conductor 11 of two ends of an array of the conductors 11 may be used as the ground line. When the plurality of conductors 11 include the ground lines 111 at the two ends, each of the ground lines 111 at the two ends may has the bent portion 111D, or only one of the ground lines 111 may have the bent portion 111D.

Although the ground line 111 has been described so far using the example in which the ground line 111 is divided into three members of the first member 111A, the second member 111B, and the third member 111C, the ground line 111 may be divided into two along the longitudinal axis, or may be divided into four or more. Further, the ground line 111 does not have to be divided. In this case, the ground line 111 may include a plurality of layers of two or more layers, and the bent portion 111D is formed by bending at least one of the plurality of layers so as to be positioned on the upper surface 131 of the metal foil 13. When the ground line 111 has two layers, one of the two layers closer to the metal foil 13 may have the bent portion 111D, and the other layer farther from the metal foil 13 may function as a terminal. The other layer does not have the bent portion 111D, and thus are continuously provided from end to end along the longitudinal axis without interruption.

The bent portion 111D may be provided at one end or two ends of the ground line 111 in the longitudinal axis. In a cross section perpendicular to the longitudinal axis of the shielded flat cable 60 at a position including the bent portion 111D, the bent portion 111D overlaps the ground line 111 which includes two layers, the insulator 12, and the metal foil 13. That is, the bent portion 111D is bent along the Z-axis. By providing the bent portion 111D at the end of the ground line 111 along the longitudinal axis, the ground line 111 and the metal foil 13 can be metallically connected without dividing the ground line 111. Thus, the number of processes for manufacturing the shielded flat cable 10 can be reduced, and the productivity can be increased.

As shown in a shielded flat cable 40 shown in FIG. 4 and a shielded flat cable 50 shown in FIG. 5, at least a portion of the ground line 111 may have an exposed portion 111X exposed from the first insulator 12A. Further, the exposed portion 111X may be metallically connected to the metal foil 13.

The ground line 111 has the exposed portion 111X exposed from the first insulator 12A, and the exposed portion 111X is connected to the metal foil 13, so that the ground line 111 and the metal foil 13 can be connected more easily than in the case where the ground line 111 is bent. Thus, the productivity of the shielded flat cable can be improved.

In the shielded flat cable 40 shown in FIG. 4, the exposed portion 111X, which is a portion of the ground line 111 exposed from the first insulator 12A, is metallically connected to the metal foil 13 by a solder layer 41. It is noted that, the ground line 111 and the metal foil 13 may be connected by a metal material other than solder instead of the solder layer 41.

Further, in the shielded flat cable 50 shown in FIG. 5, the metal foil 13 is bent and connected to the exposed portion 111X, which is a portion of the ground line 111 exposed from the first insulator 12A. The shielded flat cable 50 shown in FIG. 5 may be bonded to the ground line 111 by ultrasonic bonding, soldering, or the like. The shielded flat cable 40 and the shielded flat cable 50 shown in FIG. 4 and FIG. 5 can be the same as the shielded flat cable 10 shown in FIG. 1 and the like except that the connection form between the ground line and the metal foil is different, and thus, the description thereof will be omitted.

However, for example, in order to increase the connection area between the ground line 111 and the metal foil 13, the width of the ground line 111 may be larger than the width of the other conductors 11.

Further, in the shielded flat cable 10 shown in FIG. 1, the ground line 111 is cut at the cut portion 22 and divided into a plurality of members, but in the shielded flat cable 40 and the shielded flat cable 50, the ground line 111 may be a continuous single member. This is because the ground line 111 does not have to be bent in the shielded flat cable 40 or the like. It is noted that, the number of exposed portions 111X per ground line 111 may be one, or two or more. Further, the exposed portion 111X may be provided on the entire surface of the ground line 111. Even when the exposed portion 111X is provided on the entire surface of the ground line 111, the ground line 111 and the metal foil 13 may be metallically connected at one portion or two or more portions.

### Examples

The present invention is not limited to these examples, and includes the equivalent scope and modifications thereof within the scope of exhibiting the effects of the present invention.

### (1) Evaluation Method

The Ssd21 of the produced shielded flat cable in each of the following examples was measured.

Ssd21 is the amount by which the incoming difference signal is converted to a common mode signal at the outputs. Thus, when comparing the Ssd21 with the conventional shielded flat cable, the wider the relatively low-frequency region is, the better the noise shielding characteristics are.

The lengths of the shielded flat cables to be measured for Ssd21 were set to 3 m, and Ssd21 was measured by the network analyzer (manufactured by Keysight Co., Ltd., Model: M9037A, M9375A).

### (2) Producing Conditions of Shielded Flat Cable

The conditions and results of the first example and the second example will be described below. The first example is an example, and the second example is a comparative example.

### First Example

The shielded flat cable 10 having a structure in which a cross section perpendicular to the longitudinal axis is shown in FIG. 1 was produced. In the produced shielded flat cable, the lower surface has the structure as shown in FIG. 2 and the upper surface has the structure as shown in FIG. 3.

The produced shielded flat cable 10 includes the plurality of conductors 11 arranged in parallel, the insulator 12 including the first insulator 12A and the second insulator 12B, the metal foil 13, the shield layer 14 disposed so as to surround outer peripheries of the insulator 12 and the metal foil 13, and the interposed member 15.

### (Conductor)

The plurality of conductors 11 were flat conductors made of copper. The conductor 11 was 0.3 mm wide and 0.035 mm thick. The conductors 11 are arranged so that the distances between the centers of the adjacent conductors 11 are equal, and the conductor 11 of two ends along the array is set as the ground line 111.

As shown in FIG. 2 and FIG. 3, the ground line 111 is cut at the cut portion 22 and divided into a plurality of members such as the first member 111A, the second member 111B, and the third member 111C along the longitudinal axis of the ground line 111. As shown in FIG. 1 and FIG. 3, the ground line 111 has the bent portion 111D that is bent to be positioned on the upper surface 131 of the metal foil 13 at the end of the ground line 111 formed by being divided, and is metallically connected to the metal foil 13. The bent portion 111D is bonded to the metal foil 13 by soldering.

As shown in FIG. 3, the ground line 111 has four bent portions 111D per one ground line 111, and one ground line 111 is bonded to the metal foil 13 at four positions.

### (Insulator)

The first insulator 12A is disposed on the upper surface 11X of the plurality of conductors 11, the second insulator 12B is disposed on the lower surface 11Y of the plurality of conductors 11, and the first insulator 12A and the second insulator 12B are bonded to each other, thereby forming the insulator 12. The first insulator 12A and the second insulator 12B are directly in contact with each other and bonded to each other in a portion where the conductor 11 is not disposed.

Each of the first insulator 12A and the second insulator 12B includes a base material and an adhesive layer. Both the first insulator 12A and the second insulator 12B have the same structure and material, using a base material with a thickness of 11 μm formed of polyethylene terephthalate as the base material. The adhesive layer was formed of polypropylene and had a thickness of 5 μm.

As shown in FIG. 2, at the distal end portion 21, which is the end portion of the shielded flat cable 10 along the longitudinal axis, the second insulator 12B disposed on the lower surface 11Y of the conductor 11 is removed to expose the end portion of the conductor 11 along the longitudinal axis. For example, the bent portion 111D of the ground line 111 and the terminal 111E of the ground line 111 exposed at the distal end portion 21 are positioned at the two ends of the first member 111A and electrically connected to each other.

### (Metal Foil)

A copper foil was used as the metal foil 13. As shown in FIG. 1, the metal foil 13 is disposed to surround the region R1 where the plurality of conductors 11 except the ground line 111 are disposed in a cross section perpendicular to the longitudinal axis of the shielded flat cable 10. As shown in FIG. 3, the metal foil 13 covers the entire surfaces of the plurality of conductors 11 except the ground line 111 from the first end portion 31A to the second end portion 31B along the longitudinal axis of the plurality of conductors 11 in the region surrounded by the shield layer 14.

### (Interposed Member)

As shown in FIG. 1, the first interposed member 15A and the second interposed member 15B are disposed on the upper surface of the first insulator 12A and the lower surface of the second insulator 12B, respectively. The first interposed member 15A was disposed between the first insulator 12A and the metal foil 13.

Polyethylene was used as the material of the interposed member.

As shown in FIG. 1, the interposed member 15 is disposed to surround the region R1 where the plurality of conductors 11 except the ground line 111 are disposed in a cross section perpendicular to the longitudinal axis of the shielded flat cable 10. As shown in FIG. 3, the interposed member 15 covers the entire surfaces of the plurality of conductors 11 except the ground line 111 from the first end portion 31A to the second end portion 31B along the longitudinal axis of the plurality of conductors 11 in the region surrounded by the shield layer 14.

### (Shield Layer)

The shield layer 14 was disposed outside the insulator 12.

Specifically, as shown in FIG. 1, the shield layer 14 is disposed to surround outer peripheries of the insulator 12 and the metal foil 13. A conductive adhesive is disposed on a surface of the shield layer 14 facing the metal foil 13, and the metal foil 13 and the metal layer 141 of the shield layer 14 are connected to each other by the conductive adhesive.

As shown in FIG. 1, the shield layer 14 has a structure in which the metal layer 141 and the resin layer 142 are laminated, and an aluminum foil is used as the metal layer 141 and polyethylene terephthalate (PET) is used as the resin layer 142. The thickness of the shield layer 14 was 9 μm. The shield layer 14 was disposed such that the metal layer 141 was inside, that is, faced the plurality of conductors 11.

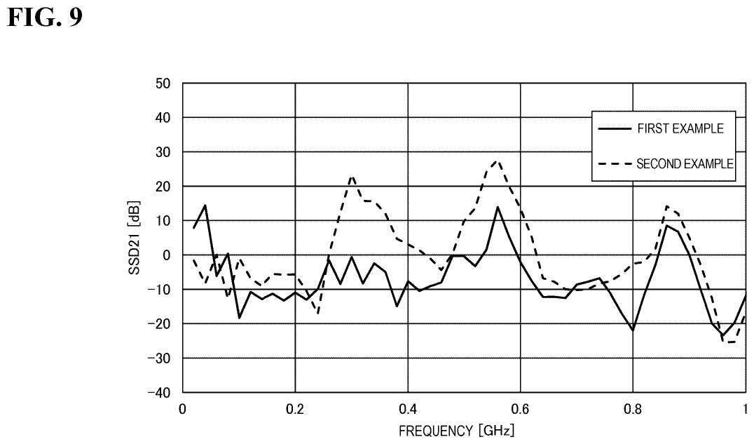

The Ssd21 of the shielded flat cable 10 thus obtained was evaluated. The evaluation results are shown in FIG. 9.

### Second Example

The shielded flat cable 60 having a structure in which a cross section perpendicular to the longitudinal axis is shown in FIG. 6 was produced. The produced shielded flat cable 60 has the structure of the lower surface and the upper surface shown in FIG. 7 and FIG. 8, respectively.

The produced shielded flat cable 60 includes the plurality of conductors 11 arranged in parallel, the insulator 12 including the first insulator 12A and the second insulator 12B, and the shield layer 14 disposed so as to surround outer peripheries of the insulator 12.

As shown in FIG. 7, the shielded flat cable 60 is provided with a window portion 71 in which the second insulator 12B is removed on the lower surface, and the ground line 111 is cut at the window portion 71, and the ground line 111 is divided into the first member 111A, the second member 111B, and the third member 111C. The shielded flat cable 60 is folded back along the longitudinal axis of the ground line 111 together with the first insulator 12A with respect to the first member 111A and the third member 111C of the cut ground line 111. The ground line 111 is positioned at the second position from both end portions along the array of the plurality of conductors 11. An insulator made of the same material as the second insulator 12B is disposed again in the window portion 71. It is noted that, since the window portion 71 is provided, the interposed member 15 is not provided at a portion where the window portion 71 is provided when FIG. 7 is viewed in the horizontal cross section. That is, the conductor 11 has a portion where impedance matching cannot be achieved.

Thus, as shown in FIG. 6, in a cross section perpendicular to the longitudinal axis of the shielded flat cable 60, a third insulator 12C, which is the folded first insulator 12A, is disposed on the first insulator 12A, and a folded-back portion 61, which is the folded ground line 111, is disposed.

The shield layer 14 was disposed to surround the insulator 12 and the outer periphery of the folded-back portion 61. A conductive adhesive is disposed on a surface of the shield layer 14 facing the folded-back portion 61, and the folded-back portion 61 and the metal layer 141 of the shield layer 14 are electrically connected by the conductive adhesive.

The shielded flat cable 60 uses the same materials and members as the shielded flat cable 10 of the first example except the above-described structure, and thus the description thereof will be omitted.

The Ssd21 of the shielded flat cable 60 thus obtained was evaluated. The evaluation results are shown in FIG. 9.

According to the results shown in FIG. 9, it was confirmed that the shielded flat cable 10 of the first example had an improved measured Ssd21 over almost the entire region of frequencies, compared to the shielded flat cable 60 of the second example. It was confirmed that the shielded flat cable 10 of the first example had a smaller Ssd21 by 20 dB than the shielded flat cable 60 of the second example in a significant band. Thus, it was confirmed that a shielded flat cable having excellent noise shielding characteristics could be obtained by adopting the structure of the shielded flat cable of the first example in which the metal foil 13 was disposed between the ground line 111 and the shield layer 14 and connected thereto.

What is claimed is:

1. A shielded flat cable comprising:
a plurality of conductors arranged in parallel and including a ground line;
an insulator including a first insulator disposed on an upper surface of the plurality of conductors and a second insulator disposed on a lower surface of the plurality of conductors;
a metal foil disposed above the first insulator and electrically connected to the ground line; and
a shield layer electrically connected to the metal foil and disposed so as to surround outer peripheries of the insulator and the metal foil.

2. The shielded flat cable according to claim 1,
wherein the ground line and the metal foil are metallically connected to each other.

3. The shielded flat cable according to claim 1,
wherein the ground line is disposed at an end of an array of the plurality of conductors.

4. The shielded flat cable according to claim 1, further comprising:
an interposed member disposed between the insulator and the metal foil.

5. The shielded flat cable according to claim 4,
wherein the interposed member is disposed so as to cover the plurality of conductors from a first end portion to a second end portion along a longitudinal axis in a region surrounded by the shield layer.

6. The shielded flat cable according to claim 1,
wherein the ground line is divided into a plurality of members along a longitudinal axis of the ground line, and the ground line has at least one bent portion at an end of the ground line formed by being divided, the bent portion being bent to be positioned on an upper surface of the metal foil and metallically connected to the metal foil.

7. The shielded flat cable according to claim 6,
wherein the at least one bent portion comprises a plurality of bent portions.

8. The shielded flat cable according to claim 6, further comprising:
an interposed member disposed between the insulator and the metal foil,
wherein, in a cross section perpendicular to a longitudinal axis of the shielded flat cable at a position including the at least one bent portion, the at least one bent portion overlaps the insulator, the interposed member, and the metal foil.

9. The shielded flat cable according to claim 1,
wherein the ground line includes a plurality of layers, and has a bent portion at one end or two ends along a longitudinal axis of the ground line, the bent portion being formed by bending at least one of the plurality of layers so as to be positioned on an upper surface of the metal foil and being metallically connected to the metal foil.

10. The shielded flat cable according to claim 1,
wherein the ground line has an exposed portion at least partially exposed from the first insulator, and
wherein the exposed portion is metallically connected to the metal foil.

11. The shielded flat cable according to claim 1,
wherein, in a cross section perpendicular to a longitudinal axis of the shielded flat cable, the metal foil is disposed so as to cover the plurality of conductors except at least the ground line.
